(19) United States
(12) Patent Application Publication
(10) Pub. No.: US 2011/0285058 A1
(43) Pub. Date: Nov. 24, 2011

(54) METHOD FOR PRODUCING A MOLDED ARTICLE OF AN ORGANIC FIBER-REINFORCED POLYOLEFIN RESIN

(75) Inventors: Yoshitaka Kobayashi, Ichihara-shi (JP); Yuya Yamamoto, Ichihara-shi (JP); Nobuhiro Usui, Ichihara-shi (JP)

(73) Assignee: SUMITOMO CHEMICAL COMPANY, LIMITED, Tokyo (JP)

(21) Appl. No.: 13/107,342

(22) Filed: May 13, 2011

(30) Foreign Application Priority Data
May 20, 2010 (JP) JP2010-116627

(51) Int. Cl. B29C 45/03

(52) U.S. Cl. 264/328.7

(57) ABSTRACT

A method for producing a molded article of an organic fiber-reinforced polyolefin resin from a polyolefin resin and an organic fiber having a weight average length of 4 mm or more includes the following steps (1) a preparing step of preparing an organic fiber-reinforced polyolefin resin containing a polyolefin resin and an organic fiber having a weight average length of 4 mm or more, (2) a melting step of melting the organic fiber-reinforced polyolefin resin to obtain a molten organic fiber-reinforced polyolefin resin, (3) a filling step of filling the molten organic fiber-reinforced polyolefin resin into a mold cavity which is formed by a pair of molds capable of being moved relatively toward or away from each other and which defines a changeable cavity clearance between them, and (4) a removing step of cooling the filled molten organic fiber-reinforced polyolefin resin to form a molded article of an organic fiber-reinforced polyolefin resin and removing the molded article of the organic fiber-reinforced polyolefin resin from the mold cavity, wherein the following Formula (I) is satisfied in the step of filling,

0.20≦C/L≦1.0 (I)

where C represents the maximum of the cavity clearance (mm) taken in the filling step, and L represents a weight average length (mm) in the organic fiber-reinforced polyolefin resin resulting from the preparing step.

### BACKGROUND OF THE INVENTION

1. Field of the Invention

The present invention relates to a method for producing a molded article of an organic fiber-reinforced polyolefin resin.

2. Description of the Related Art

Molded articles made of a fiber-reinforced polyolefin resin comprising a polyolefin resin and a fiber have been used in various fields because of their superior rigidity. Recently, not only the use of inorganic fibers represented by conventional glass fibers but also the use of organic fibers has been proceeded.

In the production of a molded article using a fiber-reinforced polyolefin resin containing a polyolefin resin and an organic fiber, as the organic fiber to be used becomes longer, the mechanical strength of a resulting molded article increases, but organic fibers become prone to be entangled to form a ball-shaped fiber mass during molding the fiber-reinforced polyolefin resin.

The generation of a fiber mass may cause variation in the strength of a molded article to be obtained or the apparent deterioration of a molded article to be obtained.

As a method for inhibiting the generation of a fiber mass, JP 2007-245348 A discloses a method that comprises stretching a resin composition comprising a resin, an organic fiber and optionally a material to enhance the capability of the fiber of being stretched.

Although the method disclosed in JP 2007-245348 A in which the generation of a fiber mass is inhibited by stretching a fiber was effective in the case of using a relatively short fiber of about 1 mm in length, it failed to produce a sufficient effect when using a long fiber.

### SUMMARY OF THE INVENTION

It is an object of the present invention to provide a method for producing a molded article of an organic fiber reinforced polyolefin resin, by which method it is possible to inhibit the generation of fiber mass even in the production of a molded article using an organic fiber-reinforced polyolefin resin composed of relatively long organic fibers and a polyolefin resin, so that a molded article with good appearance can be obtained.

The present invention is directed to:

<1> A method for producing a molded article made of an organic fiber-reinforced polyolefin resin comprising a polyolefin resin and an organic fiber having a weight average length of 4 mm or more, wherein the method comprises the following steps (1) to (4):

(1) a preparing step of preparing an organic fiber-reinforced polyolefin resin comprising a polyolefin resin and an organic fiber having a weight average length of 4 mm or more,

(2) a melting step of melting the organic fiber-reinforced polyolefin resin to obtain a molten organic fiber-reinforced polyolefin resin,

(3) a filling step of filling the molten organic fiber-reinforced polyolefin resin into a mold cavity which is formed by a pair of molds capable of being relatively toward or away from each other and which defines a changeable cavity clearance between them, and

(4) a removing step of cooling the filled molten organic fiber-reinforced polyolefin resin to form a molded article of an organic fiber-reinforced polyolefin resin and removing the molded article of the organic fiber-reinforced polyolefin resin from the mold cavity,

wherein the following Formula (I) is satisfied in the step of filling,

0.20≦C/L≦1.0 (I)

where C represents the maximum of the cavity clearance (mm) taken in the filling step, and L represents a weight average length (mm) in the organic fiber-reinforced polyolefin resin resulting from the preparing step.

The “organic fiber-reinforced polyolefin resin” means an organic fiber reinforced polyolefin resin composition comprising an organic fiber and a polyolefin resin.

The present invention successfully has provided a method for producing a molded article of an organic fiber-reinforced polyolefin resin, by which method it is possible to inhibit the generation of a fiber mass even in the production of a molded article using an organic fiber-reinforced polyolefin resin composed of relatively long organic fibers and a polyolefin resin, so that a molded article with good appearance can be obtained.

### BRIEF DESCRIPTION OF THE DRAWINGS

In the drawings,

FIG. 1 is a cross-sectional view of a mold to be used for the method of the present invention taken along the direction perpendicular to the molding surface of the mold.

FIG. 2 is a cross-sectional view taken along the direction perpendicular to the molding surface of a mold, the view showing a step of the production method of the present invention.

FIG. 3 is a cross-sectional view taken along the direction perpendicular to the molding surface of a mold, the view showing another step of the production method of the present invention.

FIG. 4 is a cross-sectional view taken along the direction perpendicular to the molding surface of a mold, the view showing still another step of the production method of the present invention.

The signs in the drawings have meanings shown below:

1: Movable mold; 2: Stationary mold; 3: Cavity; 4: Gate portion; 5: Molten resin supply conduit; 6: Valve pin; 7: Molten resin; M: Mold.

### DESCRIPTION OF THE PREFERRED EMBODIMENTS

Preferred embodiments of the method of the present invention will be described in detail below with reference to drawings. The same part is marked with the same symbol and overlapping explanations are omitted. As shown in the drawings, the X-axis and the Y-axis make 90 degrees mutually on the horizontal surface perpendicular to the molding surfaces of the mold, and if necessary, an explanation will be made with reference to the X-axis and the Y-axis.

### [Mold]

A pair of molds to be used in the present invention can be moved relatively forward or away from each other. Both the molds may be movable.

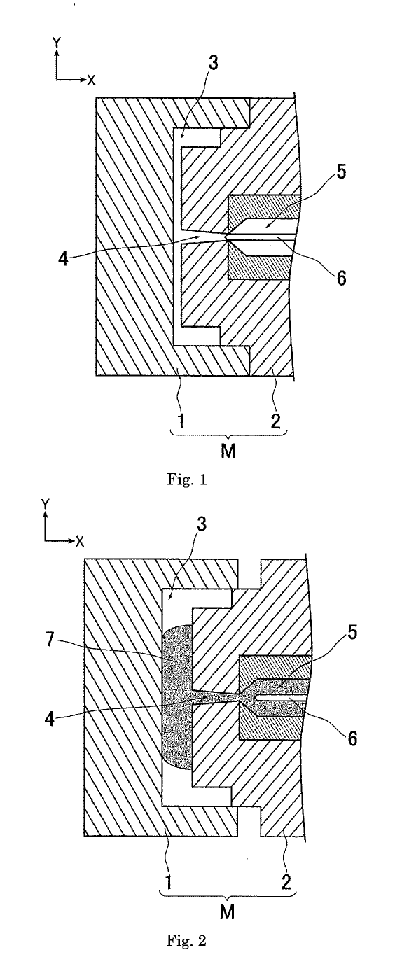

The mold M shown in FIGS. 1 to 4 is a pair of molds for injection molding, which includes a stationary mold 2 and a movable mold 1. The mold to be used for the present invention is explained with reference to figures below.

The movable mold 1 and the stationary mold 2 are arranged to face each other in the X-axial direction. By moving the movable mold 1 toward the stationary mold 2 from a state where the movable mold 1 and the stationary mold 2 are not in contact with each other, thereby bringing the movable mold 1 into contact with the stationary mold 2, a mold cavity 3 is formed by these molds. The movable mold 1 reciprocates in the X-axial direction by the action of a mold opening/closing mechanism, not shown. The mold cavity 3 is shrunk by the movement of the movable mold 1 toward the stationary mold 2 from a state shown in FIG. 2 where the stationary mold 2 and the movable mold 1 have started their contact. The cavity clearance is a distance between the molding surface of the stationary mold 2 and the molding surface of the movable mold 1 facing that molding surface of the mold 2. The cavity clearance can be varied by moving the movable mold.

In FIG. 1, the stationary mold 2 and the movable mold 1 are being clamped. The shape of the mold cavity 3 formed by the stationary mold 2 and the movable mold 1 when these molds have been clamped corresponds to the shape of a desired molded article.

The stationary mold 2 is provided with a gate portion 4 for supplying a molten organic fiber-reinforced polyolefin resin (hereinafter referred to as “molten resin”) to the mold cavity 3 and the gate portion 4 is connected to a molten resin supply conduit 5. The tip portion of molten resin supply conduit 5 is provided with an opening/closing mechanism, such as a valve pin 6, being capable of closing the conduit. The valve pin 6 can reciprocate in the X-axial direction. When a molten resin 7 is supplied, the valve pin 6 is backed, so that a channel in which the molten resin 7 flows can be secured, and after the completion of supplying the molten resin 7, the valve pin 6 is moved forward, so that the channel of the molten resin 7 can be closed. The valve pin 6 is driven by a driving source (not shown), such as an oil pressure, an air pressure or an electric driver. When using a mold having two or more gate portions 4 each having a valve pin 6, it is possible to freely control the timing of supplying a molten resin to the mold cavity 3 through each gate portion 4 by controlling a movement of each valve pin.

The area of the outlet of the gate portion 4 is preferably from 7 mm² to 50 mm². If the area is within the above range, the organic fiber contained in a molten resin is prevented from being cut when the molten resin is supplied into the mold cavity and a gate portion can be cut off easily from the product portion of a molded article after taking the molded article out from the molds.

The position and the number of the gate portion 4 are determined appropriately depending upon the shape and the size of a molded article to be produced. Although in this example, the mold is arranged so that it can be moved in the X-axial direction, the mold may also be arranged so that it can be moved in the Y-axial direction.

### [Method for Producing a Molded Article]

A method for producing a molded article of an organic fiber-reinforced polyolefin resin using such a mold will be described.

The method of the present invention is a method for producing a molded article of an organic fiber-reinforced polyolefin resin comprising a polyolefin resin and an organic fiber having a weight average length of 4 mm or more, wherein the method comprises the following steps (1) to (4):

(1) a preparing step of preparing an organic fiber-reinforced polyolefin resin comprising a polyolefin resin and an organic fiber having a weight average length of 4 mm or more,

(2) a melting step of melting the organic fiber-reinforced polyolefin resin to obtain a molten organic fiber-reinforced polyolefin resin,

(3) a filling step of filling the molten organic fiber-reinforced polyolefin resin into a mold cavity which is formed by a pair of molds capable of being moved relatively toward or away from each other and which defines a changeable cavity clearance between them, and

(4) a removing step of cooling the filled molten organic fiber-reinforced polyolefin resin to form a molded article of an organic fiber-reinforced polyolefin resin and removing the molded article of the organic fiber-reinforced polyolefin resin from the mold cavity,

wherein the following Formula (I) is satisfied in the step of filling,

0.20≦C/L≦1.0 (I)

where C represents the maximum of the cavity clearance (mm) taken in the filling step, and L represents a weight average length (mm) in the organic fiber-reinforced polyolefin resin resulting from the preparing step.

The preparing step is a step of preparing an organic fiber-reinforced polyolefin resin comprising a polyolefin resin and an organic fiber having a weight average length of 4 mm or more. The preparing step will be described later.

The melting step is described. The melting step is a step of melting the organic fiber-reinforced polyolefin resin to obtain a molten organic fiber-reinforced polyolefin resin.

In the melting step is used a melting apparatus equipped with a screw. The screw in the melting apparatus is preferably a deeply grooved screw with a small compression ratio in order to inhibit the breakage of the organic fiber in the melting step.

For the purpose of inhibiting the breakage of the organic fiber in the melting step, it is preferred to adjust the screw rotation speed or the back pressure to be low or adjust a temperature at which the organic fiber-reinforced polyolefin resin is molten to be low. Here, “melting” is synonymous with “plasticizing” and it means to soften an organic fiber-reinforced polyolefin resin by the addition of heat and a mechanical operation to a state in which the resin can be molded.

Specifically, the temperature at which the organic fiber-reinforced polyolefin resin is molten is preferably not lower than the melting point of the polyolefin resin in the organic fiber-reinforced polyolefin resin and not higher than (Tm −30)° C. where the melting point of the organic fiber is represented by Tm (° C.). It is more preferably from 170° C. to 220° C., and particularly preferably from 180° C. to 200° C. By making the organic fiber-reinforced polyolefin resin in the melting step have a temperature not higher than (Tm −30)° C. as described above, it is possible to prevent the organic fiber from being cut when plasticizing the organic fiber-reinforced polyolefin resin in the melting apparatus or when feeding the molten organic fiber-reinforced polyolefin resin into the mold cavity. Therefore, it is possible to obtain a molded article of an organic fiber-reinforced polyolefin resin comprising a polyolefin resin and an organic fiber having a weight average length of 4 mm or more. This molded article is superior in strength.

Next, the filling step is described. The filling step is a step of filling the molten organic fiber-reinforced polyolefin resin into a mold cavity which is formed by a pair of molds being capable of being moved relatively toward or away from each other and which defines a changeable cavity clearance between them.

The mold temperature applied when the molten resin is supplied to the mold cavity is preferably from 10° C. to 100° C., more preferably from 30° C. to 80° C., and particularly preferably from 50° C. to 70° C.

The filling step is represented by two embodiments.

The filling step in one embodiment is called filling step (A). Filling step (A) is a step of starting feeding the molten resin into the mold cavity when the cavity clearance is C, and clamping the molds while or after feeding the molten resin. Here, C represents the maximum value of the cavity clearance in the filling step and satisfies formula (I), which will be described later. It is permissible to clamp the molds by moving the movable mold toward the stationary mold while feeding the molten resin or alternatively it is permissible to clamp the molds by moving the movable mold toward the stationary mold after completing the feeding of the molten resin. FIG. 2 shows a state in which the feeding of the molten resin 7 into the mold cavity 3 has been started when the cavity clearance is C.

The filling step in the other embodiment is called filling step (B). Filling step (B) is a step of starting feeding the molten resin into the mold cavity when the cavity clearance is smaller than C, moving the molds relatively away from each other until the cavity clearance becomes C while feeding the molten resin, and clamping the molds while or after feeding the molten resin. It is permissible to clamp the molds by moving the movable mold toward the stationary mold while feeding the molten resin or alternatively it is permissible to clamp the molds by moving the movable mold toward the stationary mold after completing the feeding of the molten resin.

FIG. 4 shows a state in which the feeding of the molten resin 7 into the mold cavity 3 has been started when the cavity clearance is smaller than C.

In filling step (B), there is no particular limitation with the cavity clearance when starting the feeding of the aforementioned molten resin 7, and it is preferably larger than the cavity clearance to be applied when clamping the molds before feeding the molten resin to the cavity and it is more preferably 1 mm or more. When the cavity clearance is 1 mm or more, a fiber mass hardly generates because the shearing force to be loaded on the molten resin does not become very large. The cavity clearance applied when starting the feeding of the molten resin should just be smaller than the maximum value (mm) C of the cavity clearance.

By starting the feeding of the molten resin when the cavity clearance is smaller than C as described above, it is possible to obtain a molded article whose appearance around a gate is better.

In filling step (B), after starting the feeding of the molten resin, the cavity clearance is expanded to C while feeding the molten resin (FIG. 2). Examples of the method of expanding the cavity clearance include a method of moving the movable mold mechanically by using the mold clamping device of an injection molding machine so that the movable mold may be moved away from the stationary mold, thereby expanding the cavity clearance, and a method of expanding the cavity clearance by using the feeding pressure of a molten resin while setting the clamping force of a mold clamping device to be low so that the movable mold can move away from the stationary mold slightly due to the feeding pressure of the molten resin.

The velocity of the movable mold in the case of expanding the cavity clearance by mechanically moving the movable mold is preferably from 0.5 mm/sec to 20 mm/sec. If it is within this range, the molding cycle fails to become long. Moreover, since the molten resin fed into the cavity expands with the expansion of the cavity clearance, deficiency in appearance, such as uneven luster, hardly generates in the surface of a molded article to be obtained. The velocity to expand the cavity clearance may be increased or decreased on the way.

Although the timing at which the expansion of the cavity clearance is stopped may be either after the whole amount of the molten resin to be fed has been fed or during the feeding of the molten resin to be fed, it is preferred to expand the cavity clearance until the cavity clearance becomes C while feeding the molten resin and then clamp the molds during further feeding the molten resin or after completing the feeding.

It is necessary to satisfy the formula (I) in both filling step (A) and filling step (B):

0.20≦C/L≦1.0 (I)

where C represents the maximum of the cavity clearance (mm) taken in the filling step, and L represents a weight average length (mm) in the organic fiber-reinforced polyolefin resin resulting from the preparing step.

If C/L is less than 0.20, the shearing force to be loaded on a molten resin becomes excessively large when the molten resin flows in the cavity, so that a fiber mass is more often generated. When C/L exceeds 1.0, the fiber mass can disappear, but a mark of feeding a molten resin appears in the surface of a molded article, so that a molded article with poor appearance may be obtained.

C/L is preferably from 0.30 to 0.70. C is preferably from 2 mm to 30 mm.

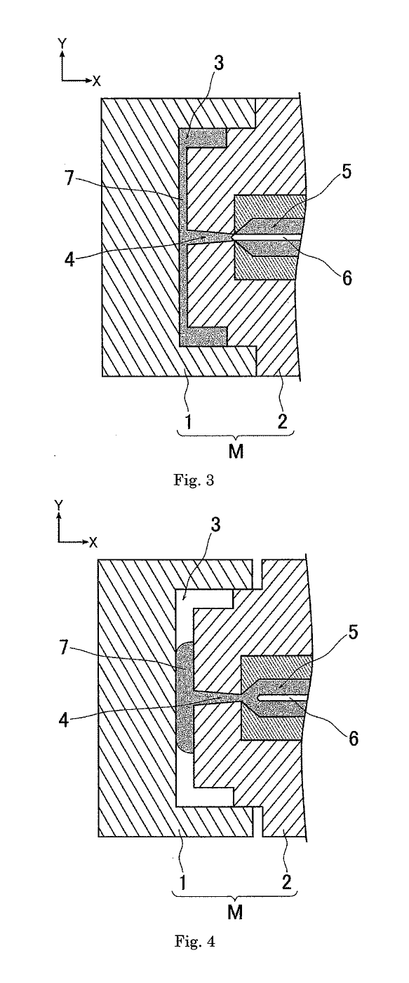

FIG. 3 shows a state in which the molds have been clamped by moving the movable mold 1 toward the stationary mold 2. The cavity has been filled up with a molten resin.

In both filling step (A) and filling step (B), in the case of clamping molds after the completion of the feeding of the molten resin, it is preferred to clamp the molds immediately after the completion of the feeding. The compression allowance (c) due to the mold clamping is determined by the volume of the molten resin fed into the cavity, the cavity clearance at the completion of the feeding of the molten resin, and the cavity clearance at the completion of the mold clamping. The compression allowance (c) is preferably 0.5 mm or more, and more preferably 1.0 mm or more. The velocity of moving the movable mold toward the stationary mold when clamping the molds is preferably from 1 mm/sec to 30 mm/sec. If the velocity has a value within the aforementioned range, it is possible to fill the fed molten resin into the mold cavity before the molten resin is cooled and therefore the shearing force to be loaded on the molten resin does not become large. Hence, a fiber mass is hardly formed.

In both filling step (A) and filling step (B), the mold cavity formed by the pair of molds when the clamping of the molds has been completed has a shape corresponding to the shape of the molded article to be produced.

The removing step is then described. The removing step is a step of cooling the filled molten organic fiber-reinforced polyolefin resin to form a molded article of an organic fiber-reinforced polyolefin resin and removing the molded article of the organic fiber-reinforced polyolefin resin from the mold cavity.

After the cooling of the molten resin filled into the cavity is completed, the movable mold 1 is moved away from the stationary mold 2 and the molded article of the organic fiber-reinforced polyolefin resin is removed.

The molded article to be obtained by the method of the present invention is composed of a polyolefin resin and an organic fiber having a weight average length of 4 mm or more. Molded articles containing organic fibers having a weight average length of 4 mm or more are superior to molded articles containing organic fibers having a weight average length of less than 4 mm in rigidity, heat resistance, impact strength, and damping property.

The method of the present invention is suitable for producing a molded article having a thickness of 3 mm or less. If a molded article of 3 mm or less in thickness is produced by a conventional method, a high shearing force is loaded on a molten resin in filling the molten resin into a cavity, so that a fiber mass will be formed.

When the molded article to be produced is not uniform in thickness, the thickness referred to in the present invention means the average of the thickness of the molded article.

In the production of a molded article having a thickness of 3 mm or less, mold clamping is carried out in filling step so that the molded article to be obtained may become 3 mm or less in thickness.

### [Organic Fiber-Reinforced Polyolefin Resin]

The “organic fiber-reinforced polyolefin resin” to be used for the present invention means an organic fiber-reinforced polyolefin resin composition comprising an organic fiber having a weight average length of 4 mm or more and a polyolefin resin. First, the organic fiber to be prepared in the preparing step is described.

### <Organic Fiber>

The organic fiber to be used in the present invention has a weight average length of 4 mm or more. Examples of the organic fiber of the present invention include a polyethylene fiber, a polypropylene fiber, an aramid fiber, a polyester fiber, a vinylon fiber, cotton, hemp, silk, and bamboo. Fibers produced by imparting electrical conductivity to organic fibers by providing a metal layer on the surface of the organic fibers may also be used.

A method of providing a metal layer on the surface of a fiber may be chosen appropriately depending upon the fiber to be used, examples thereof include vapor deposition, plating, sputtering, and ion plating. The metal to constitute the metal layer is not particularly restricted, and copper is preferred. Two or more such organic fibers may be used in combination. In particular, a polyester fiber and a vinylon fiber are preferred, and an organic fiber composed of a polyalkylene terephthalate and/or a polyalkylene naphthalene dicarboxylate is more preferred.

The organic fiber composed of a polyalkylene terephthalate and/or a polyalkylene naphthalene dicarboxylate is preferably composed of a polyalkylene naphthalene dicarboxylate.

### (Polyalkylene Naphthalene Dicarboxylate)

A polyalkylene naphthalene dicarboxylate is a product of polycondensation of an alkylene diol with a naphthalene dicarboxylic acid, and preferred is a polyester in which alkylene naphthalene dicarboxylate units represented by the following formula (P) or formula (Q) account for 80 mol % or more of the amount of all repeating units. The content of the alkylene naphthalene dicarboxylate units is preferably 90 mol % or more of the amount of all repeating units, more preferably 95 mol % or more, and even more preferably from 96 to 100 mol %;

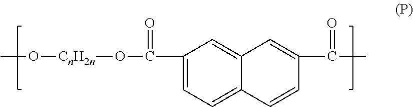

wherein in formula (P), n denotes an integer number of 1 or more;

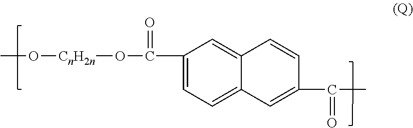

wherein in formula (Q), n denotes an integer number of 1 or more.

The alkylene group that constitutes the main chain of the alkylene naphthalene carboxylate is preferably an alkylene group having from 2 to 4 carbon atoms. Examples of the alkylene group include an ethylene group, a trimethylene group, and a tetramethylene group. The polyalkylene naphthalene dicarboxylate is preferably polyethylene naphthalene carboxylate, and more preferably polyethylene-2,6-naphthalene carboxylate.

### (Polyalkylene Terephthalate)

A polyalkylene terephthalate is a polycondensate of an alkylene diol with terephthalic acid, and preferred is a polyester in which alkylene terephthalate units represented by the following formula (R) account for 80 mol % or more of the amount of all repeating units. The content of the alkylene terephthalate units is preferably 90 mol % or more of the amount of all repeating units, more preferably 95 mol % or more, and even more preferably from 96 to 100 mol %.

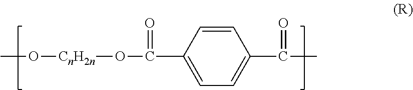

wherein in formula (R), n denotes an integer number of 1 or more.

The alkylene group that constitutes the main chain of the polyalkylene terephthalate is preferably an alkylene group having from 2 to 4 carbon atoms. Examples of the alkylene group include an ethylene group, a trimethylene group, and a tetramethylene group. Preferably, the polyalkylene terephthalate is polyethylene terephthalate.

The organic fiber composed of a polyalkylene terephalate and/or a polyalkylene naphthalene dicarboxylate may contain an additional unit as repeating unit to constitute the organic fiber. Examples of the additional unit include (a) a compound residue having two ester-forming functional groups. Examples of a compound which provides the compound residue having two ester-forming functional groups include aliphatic dicarboxylic acids, such as oxalic acid, succinic acid, sebacic acid, and dimer acid; alicyclic dicarboxylic acids, such as cyclopropane dicarboxylic acid and hexahydroterephthalic acid; aromatic dicarboxylic acids, such as phthalic acid, isophthalic acid, naphthalene-2,7-dicarboxylic acid, and diphenyl carboxylic acid; carboxylic acids, such as diphenyl ether dicarboxylic acid, diphenylsulfonic acid, diphenoxycarboxylic acid, and sodium 3,5-dicarboxybenzenesulfonate; oxycarboxylic acids, such as glycolic acid, p-oxybenzoic acid, and p-oxyethoxybenzoic acid; and oxy compounds, such as propylene glycol, trimethylene glycol, diethylene glycol, tetramethylene glycol, hexamethylene glycol, neopentylene glycol, p-xylene glycol, 1,4-cyclohexanedimethanol, bisphenol A, p,p′-dihydroxyphenylsulfone, 1,4-bis(beta-hydroxyethoxy)benzene, 2,2-bis(p-beta-hydroxyethoxyphenyl)propane, and polyalkylene glycol. Moreover, their derivatives are also available.

Polymers obtained by polymerizing the oxycarboxylic acids and/or derivatives of the oxycarboxylic acids are also examples of components that afford the additional unit.

Moreover, other examples of the component that affords the additional unit include polymers obtained by polymerizing two or more compounds of at least one compound selected from among the aforementioned carboxylic acids and derivatives of the carboxylic acids, at least one compound selected from among the aforementioned oxycarboxylic acids and derivatives of the oxycarboxylic acids, and at least one compound selected from among the aforementioned oxy compounds and derivatives of the oxy compounds.

Examples of the additional unit also include (b) a compound residue having one ester-forming functional group. Examples of compounds which provide the compound residue having one ester-forming functional group include benzoic acid, benzyloxybenzoic acid, and methoxypolyalkylene glycol.

(c) A polymer obtained by polymerizing a component that provides a compound residue having three or more ester-forming functional groups, such as glycerol, pentaerythritol, and trimethylolpropane, also can be used as a component that affords an additional unit if the polymer is substantially linear.

In the polyester which accounts for 80 mol % or more of the amount of all repeating units of the organic fiber may be contained a delusterant, such as titanium dioxide, and a stabilizer, such as phosphoric acid, phosphorous acid, and their esters.

Such an organic fiber has high mechanical impact resistance and it is superior in conformity with resin.

A molded article of an organic fiber-reinforced polyolefin resin comprising the organic fiber is superior in impact resistance to molded articles of polyolefin resins containing no organic fibers in a low temperature range where these molded articles are practically used.

The single yarn fineness of the organic fiber is preferably from 1 to 30 dtex and more preferably from 3 to 15 dtex. The upper limit of the single yarn fineness is preferably 20 dtex and more preferably 16 dtex. Preferably, the lower limit of the single yarn fineness is 2 dtex. By the use of an organic fiber whose single yarn fineness is within such a range, it becomes easy to attain the purpose of the present invention. When the single yarn fineness is less than 1 dtex, a problem with respect to spinnability tends to occur, and when the single yarn fineness is excessively high, the interfacial strength between fiber and resin tends to lower. From the viewpoint of dispersion of a fiber into a resin, the single yarn fineness is preferably 1 dtex or more, and from the viewpoint of the effect of reinforcing a resin, the single yarn fineness is preferably 30 dtex or less.

It is preferred that a sizing agent has attached to the surface of the organic fiber in an amount of from 0.1 to 10 parts by weight, more preferably from 0.1 to 3 parts by weight relative to 100 parts by weight of the organic fiber. Examples of the sizing agent include polyolefin resins, polyurethane resins, polyester resins, acrylic resins, epoxy resins, starch, vegetable oils, and mixtures of these with epoxy compounds. Preferably, the sizing agent contains at least one resin selected from the group consisting of polyolefin resins and polyurethane resins. The polyolefin resin contained in the sizing agent may be the same as the polyolefin resin to be prepared in the preparing step described below.

Next, the polyolefin resin to be prepared in the preparing step is described.

### <Polyolefin Resin>

A homopolymer of an olefin or a copolymer of two or more olefins can be used preferably as the polyolefin resin. Examples of the polyolefin resin include a polypropylene resin and a polyethylene resin. Polypropylene resin is preferred. The polyolefin resin may be either a single polyolefin resin or a mixture of two or more polyolefin resins.

Examples of the polypropylene resin include a propylene homopolymer, a propylene-ethylene random copolymer, a propylene-α-olefin random copolymer which is a copolymer of propylene with an α-olefin having 4 to 20 carbon atoms, a propylene-ethylene-α-olefin random copolymer, a propylene-based block copolymer obtained by homopolymerizing propylene to form a propylene homopolymer and then copolymerizing ethylene and propylene in the presence of the propylene homopolymer. Preferred as the polypropylene resin from the viewpoint of heat resistance are propylene homopolymers and propylene-based block copolymers produced by homopolymerizing propylene and then copolymerizing ethylene with propylene.

The content of the constitutional units derived from ethylene of the propylene-ethylene random copolymer wherein the total content of the constitutional units derived from propylene and the constitutional units derived from ethylene is 100 mol %, the content of the constitutional units derived from the α-olefin of the propylene-α-olefin random copolymer which is a copolymer of propylene with an α-olefin having 4 to 20 carbon atoms wherein the total content of the constitutional units derived from propylene and the constitutional units derived from the α-olefin is 100 mol %, and the total content of the constitutional units derived from ethylene and the constitutional units derived from the α-olefin of the propylene-ethylene-α-olefin random copolymer wherein the total amount of the constitutional units derived from propylene, the constitutional units derived from ethylene, and the constitutional units derived from the α-olefin is 100 mol % preferably are less than 50 mol %. The aforementioned content of the constitutional units derived from ethylene, the content of the constitutional units derived from the α-olefin, and the total content of the constitutional units derived from ethylene and the constitutional units derived from the α-olefin are determined by the IR method or the NMR method disclosed in “New Edition Macromolecule Analysis Handbook” (The Japan Society for Analytical Chemistry, edited by Polymer Analysis Division, Kinokuniya Co., Ltd. (1995)).

Examples of the polyethylene resin include ethylene homopolymers, ethylene-propylene random copolymers, and ethylene-α-olefin random copolymers. The content of the constitutional units derived from propylene of an ethylene-propylene random copolymer wherein the total content of the constitutional units derived from ethylene and the constitutional units derived from propylene is 100 mol %, the content of the constitutional units derived from the α-olefin contained in an ethylene-α-olefin random copolymer wherein the total content of the constitutional units derived from ethylene and the constitutional units derived from the α-olefin is 100 mol %, and the total content of the constitutional units derived from the propylene and the constitutional units derived from the α-olefin contained in an ethylene-propylene-α-olefin random copolymer wherein the total content of the constitutional units derived from ethylene, the constitutional units derived from propylene, and the constitutional units derived from the α-olefin is 100 mol % preferably are less than 50 mol %.

Examples of the α-olefin that affords the constitutional units derived from the α-olefin contained in the polyolefin resin include α-olefins having 4 to 20 carbon atoms. Specific examples include 1-butene, 2-methyl-1-propene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene, and 1-dodecene. Preferred are α-olefins having from 4 to 8 carbon atoms (e.g., 1-butene, 1-pentene, 1-hexene, and 1-octene).

The polyolefin resin can be produced by a solution polymerization method, a slurry polymerization method, a bulk polymerization method, a gas phase polymerization method, etc. Such polymerization methods may be used singly and two or more polymerization methods may be combined. Examples of a more specific production method of the polyolefin resin include the polymerization methods disclosed in “New Polymer Production Process” edited by Yasuji Saeki and Shinzo Omi, published by Kogyo Chosakai Publishing Co. (1994), JP 4-323207, JP 61-287917 and the like.

Examples of the catalyst to be used for producing the polyolefin resin include multisite catalysts and single-site catalysts. Examples of preferable multisite catalysts include catalysts obtained by using a solid catalyst component comprising a titanium atom, a magnesium atom, and a halogen atom, and preferable single-site catalysts include metallocene catalysts. When using a polypropylene resin as the polyolefin resin, examples of preferable catalysts to be used for producing the polypropylene resin include a catalyst obtained by using the solid catalyst component comprising a titanium atom, a magnesium atom, and a halogen atom.

The melt flow rate (MFR) of the polyolefin resin is preferably from 1 to 500 g/10 min, more preferably from 10 to 400 g/10 min, and even more preferably from 20 to 300 g/10 min because of the facts that it is easy to produce a molded article in which a fiber is dispersed uniformly in a resin, that a molded article with good appearance can be obtained, and that a molded article with good impact strength can be obtained. The MFR is a value measured at 230° C. and a load of 21.2 N in accordance with ASTM D1238.

When the polyolefin resin is a propylene homopolymer, the isotactic pentad fraction of the propylene homopolymer is preferably from 0.95 to 1.0, more preferably from 0.96 to 1.0, and even more preferably from 0.97 to 1.0. The isotactic pentad fraction is a fraction of units derived from propylene monomers which are each present at the center of an isotactic chain in the form of a pentad unit, namely a chain in which five propylene monomer units are meso-bonded successively, in the propylene molecular chain, as measured by the method reported in A. Zambelli et al., Macromolecules, Vol. 6, p. 925 (1973), namely, by a method using ¹³C-NMR. NMR absorption peaks are assigned according to Macromolecules, Vol. 8, p. 687 (1975).

When the polyolefin resin is a propylene block copolymer obtained by homopolymerizing propylene and then copolymerizing ethylene with propylene, the isotactic pentad fraction of the propylene homopolymer portion is preferably from 0.95 to 1.0, more preferably from 0.96 to 1.0, and even more preferably from 0.97 to 1.0.

Preferably, the polyolefin resin contains the following modified polyolefin resin.

### <Modified Polyolefin Resin>

The modified polyolefin resin is a resin obtained by modifying a polyolefin resin with a modifier selected from the group consisting of an unsaturated carboxylic acid and an unsaturated carboxylic acid derivative. The polyolefin resin that serves as a raw material of the modified polyolefin resin is the same polyolefin resin as the aforementioned polyolefin resin. The modified polyolefin resin is a resin that is obtained by making at least one modifier selected from the group consisting of unsaturated carboxylic acids and unsaturated carboxylic acid derivatives react with a homopolymer of an olefin or a copolymer of two or more olefins and that has constitutional units derived from the modifier in the molecule. Examples of the modified polyolefin resin include the following modified polyolefin resins (d), (e), and (f). One or more resins selected from among the modified polyolefin resins (d), (e), and (f) listed below can be used as the modified polyolefin resin.

(d) A modified polyolefin resin obtained by graft polymerizing a modifier to a homopolymer of an olefin.

(e) A modified polyolefin resin obtained by graft polymerizing a modifier to a copolymer obtained by copolymerizing two or more olefins.

(f) A modified polyolefin resin obtained by graft polymerizing a modifier to a block copolymer obtained by homopolymerizing an olefin and then copolymerizing two or more olefins.

The modified polyolefin resin can be produced by a solution process, a bulk process, a melt kneading process, and the like. Two or more processes may be used in combination. Specific examples of the solution process, the bulk process, the melt kneading process, and the like include the methods disclosed in “Practical Design of Polymer Alloy” Fumio Ide, Kogyo Chosakai Publishing Co. (1996), Prog. Polym. Sci., 24, 81-142 (1999) and JP 2002-308947 A, JP 2004-292581 A, JP 2004-217753 A, JP 2004-217754 A, and so on.

The modified polyolefin resin may be a commercially available modified polyolefin resin. Examples thereof include commercial name: MODIPER (produced by NOF Corp.), commercial name: BLENMER CP (produced by NOF Corp.), commercial name: BONDFAST (produced by Sumitomo Chemical Co., Ltd.), commercial name: BONDINE (produced by Sumitomo Chemical Co., Ltd.), commercial name: REXPERL (produced by Japan Polyethylene Corp.), commercial name: ADMER (produced by Mitsui Chemicals, Inc.) commercial name: MODIC AP (produced by Mitsubishi Chemical Corp.), commercial name: POLYBOND (produced by Crompton Corp.), and commercial name: YOUMEX (produced by Sanyo Chemical Industries, Ltd.).

Examples of the unsaturated carboxylic acid to be used for the production of the modified polyolefin resin include unsaturated carboxylic acids having three or more carbon atoms, such as maleic acid, fumaric acid, itaconic acid, acrylic acid, and methacrylic acid. The unsaturated carboxylic acid derivatives include anhydrides, ester compounds, amide compounds, imide compounds, and metal salts of unsaturated carboxylic acids. Specific examples of the unsaturated carboxylic acid derivatives include maleic anhydride, itaconic anhydride, methyl acrylate, ethyl acrylate, butyl acrylate, glycidyl acrylate, methyl methacrylate, ethyl methacrylate, butyl methacrylate, glycidyl methacrylate, 2-hydroxyethyl methacrylate, monoethyl maleate, diethyl maleate, monomethyl fumarate, dimethyl fumarate, acrylamide, methacrylamide, maleic acid monoamide, maleic acid diamide, fumaric acid monoamide, maleimide, N-butylmaleimid, and sodium methacrylate. For the modification of a polyolefin with an unsaturated carboxylic acid, a compound that dehydrates to generate an unsaturated carboxylic acid during the grafting step, like citric acid or malic acid, can be used as a source of the unsaturated carboxylic acid. The unsaturated carboxylic acid and the unsaturated carboxylic acid derivative preferably include acrylic acid, glycidyl methacrylate, maleic anhydride, and 2-hydroxyethyl methacrylate.

Preferably, the modified polyolefin resin is a resin obtained by graft polymerizing maleic anhydride, glycidyl methacrylate or 2-hydroxyethyl methacrylate to a polyolefin resin containing units derived from at least one olefin selected from among ethylene and propylene as main constitutional units.

For improving the mechanical strength such as impact strength, fatigue characteristics, and rigidity, of a molded article of an organic fiber-reinforced polyolefin resin containing the modified polyolefin resin, the content of the constitutional units derived from the modifier in the modified polyolefin resin is preferably from 0.1 to 10% by weight, more preferably from 0.1 to 5% by weight, even more preferably from 0.2 to 2% by weight, and particularly preferably from 0.4 to 1% by weight. The content of the constitutional units derived from the modifier is a value calculated after quantifying the absorption based on the modifier by an infrared absorption spectrum or an NMR spectrum.

When comparing cases that are equal in the content of the constitutional units derived from the modifier contained in the resin component in the organic fiber-reinforced polyolefin resin, from the viewpoint of the mechanical strength of the organic fiber-reinforced polyolefin resin, that the resin component comprises a large amount of an unmodified polyolefin resin and a small amount of a highly modified polyolefin resin in combination is preferred than that the resin component is composed of only a slightly modified polyolefin resin.

This is because if a polyolefin resin is modified with an unsaturated carboxylic acid and/or an unsaturated acid derivative, a polymer in the resulting modified polyolefin resin tends to have a molecular weight that is smaller than the molecular weight of a polymer in the polyolefin resin before the modification.

In the present invention, it is preferred to use an unmodified polyolefin resin and a modified polyolefin resin in combination.

The content of the modified polyolefin resin in the polyolefin resin of the organic fiber-reinforced polyolefin resin is preferably from 0.5 to 40% by weight, more preferably from 0.5 to 30% by weight, and even more preferably from 1 to 20% by weight from the viewpoint of improvement in the rigidity or mechanical strength of a resin component or improvement in the permeability of the resin component into an organic fiber bundle.

The content of the organic fiber and the content of the polyolefin resin in the organic fiber-reinforced polyolefin resin are preferably from 1 to 70% by weight and from 30 to 99% by weight, respectively, more preferably from 5 to 68% by weight and from 32 to 95% by weight, respectively, even more preferably from 10 to 65% by weight and from 35 to 90% by weight, respectively, particularly preferably from 15 to 60% by weight and from 40 to 85% by weight, respectively, and most preferably from 20 to 55% by weight and from 45 to 80% by weight, respectively, from the viewpoint of the improvement in the rigidity or mechanical strength of the organic fiber-reinforced polyolefin resin or the viewpoint of the appearance of a molded article.

The organic fiber-reinforced polyolefin resin may contain one or more elastomers. Examples of the elastomers include polyester-based elastomers, polyurethane-based elastomers, and PVC-based elastomers.

For example, a stabilizer such as an antioxidant, a heat stabilizer, a neutralizer, and a UV absorber, a foam inhibitor, a flame retardant, a flame retardant aid, a dispersing agent, an antistatic agent, a lubricant, an antiblocking agent, such as silica, a colorant, such as a dye and a pigment, a plasticizer, a nucleating agent, a crystallization promoter, and a foaming agent may be incorporated as an optional component into the organic fiber-reinforced polyolefin resin. The foaming agent will be described later.

Tabular, powdery, or whisker-like inorganic compounds, such as glass flake, mica, glass powder, glass beads, talc, clay, alumina, carbon black and wollastonite, may also be incorporated into the organic fiber-reinforced polyolefin resin.

Next, the fiber-reinforced polyolefin resin to be prepared in the preparing step is described.

### <Method for Producing Organic Fiber-Reinforced Polyolefin Resin>

Examples of the method for producing the organic fiber-reinforced polyolefin resin include the following methods (1) to (3).
(1) A method that comprises mixing all components to form a mixture and then melt-kneading the mixture.
(2) A method that comprises obtaining a mixture by sequentially adding all components and then melt-kneading the mixture.
(3) A pultrusion method.

In the method (1) or (2) provided above, the method of mixing the respective components may be, for example, a method in which the components are mixed with a Henschel mixer, a ribbon blender, a blender, or the like. The method of melt-kneading a mixture may be a method in which the mixture is melt-kneaded with a Banbury mixer, a plastomill, a Brabender plastograph, a single or twin screw extruder, or the like.

Preferably, the organic fiber-reinforced polyolefin resin to be prepared in the preparing step is produced by the pultrusion method. The pultrusion method is preferred from the viewpoints of the easiness of the production of an organic fiber-reinforced polyolefin resin, and the improvement in the mechanical strength such as rigidity and impact strength and the damping property of a molded article to be obtained. The pultrusion method is basically a method of impregnating a continuous fiber bundle with a resin while pulling the fiber bundle, examples of which include the following methods (1) to (3).
(1) A method that comprises passing a fiber bundle through an impregnation bath containing an emulsion, a suspension, or a solution comprising a polyolefin resin and a solvent to impregnate the fiber bundle with the emulsion, the suspension, or the solution, and then removing the solvent.
(2) A method that comprises spraying a powder of a polyolefin resin to a fiber bundle or passing a fiber bundle through a bath containing a powder of a polyolefin resin to attach the powder of the polyolefin resin to fibers, and then melting the powder to impregnate the fiber bundle with the polyolefin resin.
(3) A method that comprises passing a fiber bundle through a crosshead and at the same time feeding a molten polyolefin resin to the crosshead from an extruder or the like, thereby impregnating the fiber bundle with the polyolefin resin.

Preferably, the organic fiber-reinforced polyolefin resin to be prepared in the preparing step is produced by the above-mentioned (3), i.e., the pultrusion method using a crosshead, more preferably by a pultrusion method using a crosshead disclosed in, for example, JP 3-272830 A.

In the above-mentioned pultrusion method, the operation of impregnating the fiber bundle with the resin may be performed either in one step or separately in two or more steps.

It is also permissible to blend organic fiber-reinforced polyolefin resin pellets produced by a pultrusion method and organic fiber-reinforced polyolefin resin pellets produced by a melt-kneading method.

Because of the balance between the viewpoint of being easy to fill a molten resin into a mold cavity and the viewpoint of being able to obtain a molded article with high strength, the weight average length of the organic fiber-reinforced polyolefin resin pellets to be used in the present invention is preferably 4 mm or more, and more preferably from 4 mm to 20 mm. When it is within this range, a molded article containing an organic fiber having a weight average length of 4 mm or more can be obtained.

The length of an organic fiber-reinforced polyolefin resin pellet produced by a pultrusion method and the length of the organic fiber contained in the organic fiber-reinforced polyolefin resin pellet are equal. That the length of an organic fiber-reinforced polyolefin resin pellet and the length of the organic fiber contained in the organic fiber-reinforced polyolefin resin pellet are equal means that the length of the organic fiber contained in the organic fiber-reinforced polyolefin resin pellet is within the range of from 90 to 110% of the overall length of the pellet. The lengths shall be expressed in weight average.

In the present invention, organic fiber-reinforced polyolefin resin pellets produced by a pultrusion method are preferably used as the organic fiber-reinforced polyolefin resin.

To the organic fiber-reinforced polyolefin resin may be mixed a foaming agent during the melting step. The foaming agent to be used for the present invention is not particularly restricted and conventional chemical foaming agents and conventional physical foaming agents can be used. The added amount of the foaming agent, in the case of a chemical foaming agent, is preferably from 0.1 to 10 parts by weight and more preferably from 0.2 to 3 parts by weight relative to 100 parts by weight of the polyolefin resin. In the case of a physical foaming agent, the added amount of the foaming agent is preferably from 0.1 to 10 parts by weight, and more preferably from 0.2 to 3 parts by weight relative to 100 parts by weight of the polyolefin resin.

Examples of the chemical foaming agent include inorganic chemical foaming agents and organic chemical foaming agents. Examples of the inorganic chemical foaming agents include hydrogen carbonates such as sodium hydrogen carbonate, and ammonium carbonate. Examples of the organic chemical foaming agents include polycarboxylic acids, azo compounds, sulfonehydrazide compounds, nitroso compounds, p-toluenesulfonyl semicarbazide, and isocyanate compounds. Examples of the polycarboxylic acids include citric acid, oxalic acid, fumaric acid, and phthalic acid.

In the use of a chemical foaming agent, a masterbatch containing the chemical foaming agent in a high concentration is prepared and then the organic fiber-reinforced polyolefin resin resulting from the preparing step and the masterbatch are mixed together beforehand, so that a mixture is obtained. This mixture is used in the melting step.

Examples of the physical foaming agent include inert gas, such as nitrogen, carbon dioxide, argon, neon, and helium, and volatile organic compounds other than chlorofluorocarbons, such as butane and pentane. Among these, it is preferred to use carbon dioxide, nitrogen, or a mixture thereof. These may be used singly or two or more of these may be used in combination. The physical foaming agent and the chemical foaming agent may be used together, and the added amount of the chemical foaming agent in this case is preferably from 0.1 to 10 parts by weight, more preferably from 0.2 to 8 parts by weight relative to 100 parts by weight of the polyolefin resin as previously described.

The physical foaming agent may be injected into the nozzle or cylinder of an injection molding machine during the melting step. Since it is easy to mix a molten resin and a physical foaming agent uniformly, a method of injecting the physical foaming agent into a cylinder in which an organic fiber-reinforced polyolefin resin is melted is preferred.

Examples of the applications of molded articles to be obtained by the method of the present invention include automotive parts, such as interior parts and exterior parts of automobiles, parts in engine rooms, parts in storage rooms, parts of motorcycles, parts of furniture or electric products, and building materials. Molded articles to be obtained by the method of the present invention are useful particularly as automotive parts.

### EXAMPLES

The present invention is hereafter further explained on the basis of Examples, but the invention is not limited to the Examples.

In Examples or Comparative Examples were used the resins given below.

(1) Organic fiber: PEN fiber (diameter of single yarn: 33 μm, the organic fiber has been surface-treated with 3% by weight of polyurethane resin.)
(2) Modified polyolefin resin: maleic anhydride-modified polypropylene resin prepared by the method disclosed in Example 1 of JP 2004-197068 (MFR: 60 g/10 min, the maleic anhydride-grafted amount: 0.6% by weight)
(3) Polyolefin resin: Sumitomo Noblen 501E1 (produced by Sumitomo Chemical Co., Ltd., MFR: 120 g/10 min)

Organic fiber-reinforced polyolefin resin pellets having a pellet length of 11 mm were prepared by a pultrusion method so that the above-mentioned (1), (2), and (3) might account for 30% by weight, 3% by weight, and 67% by weight, respectively.

### [Method of Evaluation]

### [Weight Average Length of Organic Fiber in Molded Article]

The weight average length of the organic fibers in a molded article was measured by the method disclosed in JP 2002-5924 A with an omission of an ashing step. Specifically, the length of a fiber was measured in following procedures (ii) to (iv):

(ii) dispersing a fiber in a liquid of a weight that is 1,000 or more times the weight of the fiber,

(iii) from the uniform dispersion liquid, sampling a portion in such an amount that the fiber is contained in an amount within the range of 0.1 to 2 mg,

(iv) collecting fibers by filtration or drying from the sampled uniform dispersion liquid and measuring the length of each of all the collected fibers, followed by calculating a weight average length.

### Example 1

A molded article of an organic fiber-reinforced polyolefin resin was produced by the following method using the above-mentioned organic fiber-reinforced polyolefin resin pellets.

An injection molding machine ES2550/400HL-MuCell (mold clamping force: 400 tons) manufactured by ENGEL was used as an injection molding machine, and a mold with a molded product part in a box shape having dimensions of 350 mm by 450 mm, 70 mm in height, and 1.5 mm in thickness (gate structure: valve gate) was used as a mold. Organic fiber-reinforced polyolefin resin pellets in a volume such that a resulting molded article would have a size of 350 mm×450 mm×1.5 mm were prepared. The organic fiber-reinforced polyolefin resin pellets were melted in a cylinder of 180° C., thereby forming a molten organic fiber-reinforced polyolefin resin. While adjusting the mold cavity temperature to 50° C. and maintaining the cavity clearance of the mold at 3.5 mm, the molten organic fiber-reinforced polyolefin resin was fed into the mold cavity, and after the completion of the feeding, the movable mold was moved toward the stationary mold at a speed of 2 mm/sec until the cavity clearance became set to 1.5 mm, so that mold clamping was performed. Subsequently, the molten organic fiber-reinforced polyolefin resin filled in the cavity was cooled for 20 seconds to solidify, so that a molded article was obtained. The results were shown in Table 1.

### Example 2

A molded article was obtained in the same manner as in Example 1, except for starting feeding a molten organic fiber-reinforced polyolefin resin when the cavity clearance was 2.5 mm, continuing the feeding of the molten organic fiber-reinforced polyolefin resin while expanding the cavity clearance until the cavity clearance became 3.5 mm, and, after the completion of the feeding, clamping the molds at a speed of 2 mm/sec until the cavity clearance became 1.5 mm. The results were shown in Table 1.

### Comparative Example 1

A molded article was obtained in the same manner as in Example 1, except for feeding a molten organic fiber-reinforced polyolefin resin while maintaining the cavity clearance at 1.5 mm, and then continuously cooling it for 20 seconds. The results were shown in Table 1.

### Comparative Example 2

Organic fiber-reinforced polyolefin resin pellets in a volume such that a resulting molded article would have a size of 350 mm×450 mm×2.0 mm were prepared. The organic fiber-reinforced polyolefin resin pellets were melted, thereby forming a molten organic fiber-reinforced polyolefin resin. A molded article was obtained in the same manner as in Comparative Example 1, except for feeding a molten organic fiber-reinforced polyolefin resin into a cavity while maintaining the cavity clearance at 2.0 mm. The results were shown in Table 1.

### Example 3

A molded article of an organic fiber-reinforced polyolefin resin was produced by the following method using the above-mentioned organic fiber-reinforced polyolefin resin pellets.

An injection compression molding machine SLIM10e16 (mold clamping force: 100 tons) manufactured by SATOH MACHINERY WORKS Co., Ltd. was used as an injection molding machine, and a mold with a molded product part in a flat panel shape having dimensions of 390 mm by 480 mm, and 1.6 mm in thickness (gate structure: valve gate) was used as a mold. Organic fiber-reinforced polyolefin resin pellets in a volume such that a resulting molded article would have a size of 390 mm×480 mm×1.6 mm were prepared. The organic fiber-reinforced polyolefin resin pellets were melted in a cylinder of 180° C., thereby forming a molten organic fiber-reinforced polyolefin resin. While adjusting the mold cavity temperature to 50° C. and maintaining the cavity clearance of the mold at 9 mm, the molten organic fiber-reinforced polyolefin resin was fed into the mold cavity, and after the completion of the feeding, the movable mold was moved toward the stationary mold at a speed of 10 mm/sec until the cavity clearance became set to 1.6 mm, so that mold clamping was performed. Subsequently, the molten organic fiber-reinforced polyolefin resin filled in the cavity was cooled for 20 seconds to solidify, so that a molded article was obtained. The results were shown in Table 1.

### Comparative Example 3

A molded article was obtained in the same manner as in Example 3, except for feeding a molten organic fiber-reinforced polyolefin resin into a cavity while maintaining the cavity clearance at 13 mm, and then continuously cooling it for 20 seconds. The results were shown in Table 1.

TABLE 1

| | | | Comparative | Comparative | | Comparative |
|---|---|---|---|---|---|---|
| | Example 1 | Example 2 | Example 1 | Example 2 | Example 3 | Example 3 |
| Weight average | 11 | 11 | 11 | 11 | 11 | 11 |
| length L (mm) of | | | | | | |
| organic fiber in resin | | | | | | |
| pellet | | | | | | |
| Molded article | 1.5 | 1.5 | 1.5 | 2.0 | 1.6 | 1.6 |
| thickness (mm) | | | | | | |
| Cavity clearance C | 3.5 | 2.5 | 1.5 | 2.0 | 7.0 | 13.0 |
| (mm) at the starting | | | | | | |
| of the feeding of | | | | | | |
| molten organic | | | | | | |
| fiber-reinforced | | | | | | |
| polyolefin resin | | | | | | |
| Cavity clearance C | — | 3.5 | — | — | — | — |
| (mm) at which mold | | | | | | |
| opening is stopped | | | | | | |
| Cavity clearance | 1.5 | 1.5 | — | — | 1.6 | 1.6 |
| (mm) at the | | | | | | |
| completion of mold | | | | | | |
| clamping | | | | | | |
| Weight average | 8.0 | 8.0 | | | | |
| length of fibers in | | | | | | |
| molded article (mm) | | | | | | |
| C/L | 0.32 | 0.32 | 0.14 | 0.18 | 0.64 | 1.18 |
| Presence of fiber | No | No | Yes | Yes | No | No |
| mass | | | | | | |
| Appearance near | Good | Good | Good | Good | Good | Bad |
| gate portion (resin | | | | | | |
| feeding mark) | | | | | | |

1. A method for producing a molded article of an organic fiber-reinforced polyolefin resin comprising a polyolefin resin and an organic fiber having a weight average length of 4 mm or more, wherein the method comprises the following steps (1) to (4):
(1) a preparing step of preparing an organic fiber-reinforced polyolefin resin comprising a polyolefin resin and an organic fiber having a weight average length of 4 mm or more,
(2) a melting step of melting the organic fiber-reinforced polyolefin resin to obtain a molten organic fiber-reinforced polyolefin resin,
(3) a filling step of filling the molten organic fiber-reinforced polyolefin resin into a mold cavity which is formed by a pair of molds capable of being moved relatively toward or away from each other and which defines a changeable cavity clearance between them, and
(4) a removing step of cooling the filled molten organic fiber-reinforced polyolefin resin to form a molded article of an organic fiber-reinforced polyolefin resin and removing the molded article of the organic fiber-reinforced polyolefin resin from the mold cavity,
wherein the following Formula (I) is satisfied in the step of filling,
0.20≦C/L≦1.0 (I)
where C represents the maximum of the cavity clearance (mm) taken in the filling step, and L represents a weight average length (mm) in the organic fiber-reinforced polyolefin resin resulting from the preparing step.

2. The method according to claim 1, wherein the filling step is a step of starting feeding the molten organic fiber-reinforced polyolefin resin into the mold cavity when the cavity clearance is C, and clamping the molds while or after feeding the molten organic fiber-reinforced polyolefin resin.

3. The method according to claim 1, wherein the filling step is a step of starting feeding the molten organic fiber-reinforced polyolefin resin into the mold cavity when the cavity clearance is smaller than C, moving the molds relatively away from each other until the cavity clearance becomes C while feeding the molten organic fiber-reinforced polyolefin resin, and clamping the molds while or after feeding the molten organic fiber-reinforced polyolefin resin.

4. The method according to any one of claim 1, wherein the organic fiber comprises polyalkylene terephthalate and/or polyalkylene naphthalene dicarboxylate.
